(19) United States
(12) Patent Application Publication
(10) Pub. No.: US 2007/0261566 A1
(43) Pub. Date: Nov. 15, 2007

(54) Mixing and dispensing granular food products and liquid

(76) Inventors: James R. Varney, Belmont, MA (US); Bryan R. Hotaling, Harvard, MA (US); James J. Britto, Westport, MA (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/430,073

(22) Filed: May 8, 2006

(51) Int. Cl. A47J 31/057

(52) U.S. Cl. 99/300

(57) ABSTRACT

A beverage mixing and dispensing device includes a housing, a liquid supply nozzle supported by the housing and configured to dispense a stream of liquid, a liquid supply mechanism in fluid communication with the liquid supply nozzle and configured to convey a supply of liquid to the liquid supply nozzle for dispensing, and a hopper configured to store a predetermined volume of a granular food product and configured to convey a stream of the granular food product into the stream of liquid. The liquid supply nozzle is configured such that the stream of liquid and the stream of the granular food product mix mid-stream to dispense a mixed product.

### TECHNICAL FIELD

This disclosure relates to devices and methods for mixing and dispensing beverages, and more particularly to devices and methods for mixing a granular food product with liquid to form a mixed beverage.

### BACKGROUND

Methods and devices have been developed for mixing granular and/or granulated food products, such as, infant formula, iced tea, and instant coffee, with liquid to form a consumable beverage. Devices of this type can include granular food product and liquid conveyance mechanisms that are operable to regulate the volume of liquid and granular food product that are delivered to a mixing chamber for mixing prior to being dispensed to a container such as a bottle, bowl, or cup. It is also common for liquid and granular food product to be separately dispensed into a container for subsequent mixing.

When exposed to atmospheric moisture, granular food products can accumulate becoming coagulated, caked, and/or solidified. In devices of the kind mentioned above, if the granular food product coagulates, cakes, or solidifies it can prevent or hinder the conveyance and dispensing of the food product from the device and into the container. In addition, coagulation, caking, and solidification of the food product within the device may require disassembly, cleaning, and reassembly of the device for further operation.

Examples of methods and devices for use in the mixing and dispensing of granular food products and liquid are shown, for example, in U.S. Pat. Nos. 4,116,246, 5,671,325, 5,855,236, 6,118,933, 6,411,777, and 6,829,431.

### SUMMARY

According to one aspect, a beverage mixing and dispensing device includes a housing, a liquid supply nozzle supported by the housing and configured to dispense a stream of liquid (e.g., a single serving volume of liquid, e.g., 2 to 8 ounces, or more), a liquid supply mechanism in fluid communication with the liquid supply nozzle and configured to convey a supply of liquid to the liquid supply nozzle for dispensing, and a hopper configured to store a predetermined volume of a granular food product and configured to convey a stream of the granular food product (e.g., a single serving volume of granular food product) into the stream of liquid. The liquid supply nozzle is configured such that the stream of liquid and the stream of the granular food product mix mid-stream, thereby to dispense a mixed product.

In some embodiments, the liquid supply mechanism includes a liquid reservoir configured to store a predetermined volume of liquid, and a liquid pump configured to draw the supply of liquid from the predetermined volume of liquid and to convey the supply of liquid to the liquid supply nozzle. The liquid supply mechanism can also include a heating element configured to heat the supply of liquid, e.g., to a temperature of between about 90° F. to about 104° F. in about 5 minutes or less, as it is conveyed from the liquid reservoir to the liquid supply nozzle. In some cases, the liquid reservoir is removably mounted to the housing.

In some implementations, the housing defines a chamber configured to receive the hopper, which can be removably mounted within the chamber.

In some cases, the hopper includes a funnel-shaped container defining a first open end configured to receive the predetermined volume of granular food product, and including a granule compartment extending from the first open end, defining an inner surface for storing the granular food product, and terminating in a substantially cylindrical spout. The hopper can also include an electric motor disposed proximate the funnel shaped container, and an auger drivably connected to the electric motor and configured to convey the granular food product from the granule compartment through the spout. The hopper can also include one or more sweeping arms drivably connected to the electric motor and configured to loosen granular food product at the inner surface of the funnel-shaped container. For example, in some cases, the sweeping arms are configured to lift granular food product accumulated at the inner surface of the funnel-shaped container, thereby causing the granular food product to fall, due to gravity, towards the spout for dispensing.

In some embodiments, the liquid supply nozzle comprises an annular ring defining a fluid path, which extends from one or more input ports and terminates in a plurality of fluid jets. In these cases, the liquid supply nozzle can be disposed in co-axial relation with the spout of the hopper. In other embodiments, the liquid supply nozzle includes an annular ring defining a substantially frusto-conical fluid channel that is configured to dispense the stream of liquid in the form of a vortex.

In some cases, the water supply nozzle and the spout of the hopper are configured such that the stream of water converges on the stream of granular food product for mid-stream mixing in the region of the dispensing station, i.e., in a region external to the housing. The device can also include a dispensing nozzle disposed in the region of the dispensing station in a position down stream of the water supply nozzle, wherein the water supply nozzle and the spout of the hopper are configured such that the stream of water converges on the stream of granular food product for mid-stream mixing within the dispensing nozzle. In some cases, the dispensing nozzle is at least partially transparent such that a user can visibly observe the mid-stream mixing of the water and the granular food product.

According to some embodiments, the granulated food product is selected from the group consisting of: a powdered drink mix, instant coffee, and dry infant formula.

In some embodiments, the beverage mixing and dispensing device includes a dispenser actuator that is operable to actuate the hopper and liquid supply mechanism for substantially concurrent dispensing of the stream liquid and the stream of granulated food product.

According to another aspect, a mixing and dispensing device includes a housing, a liquid reservoir configured to store a predetermined volume of liquid (e.g., at least 32 ounces), a liquid supply nozzle in fluid communication with the liquid reservoir and configured to dispense a stream of liquid, a pump connected between the liquid supply nozzle and the liquid reservoir and configured to convey a supply of liquid from the liquid reservoir to the liquid supply nozzle, an electric motor, and a hopper drivably connected to the electric motor. The hopper is disposed within the housing in a position upstream of the liquid supply nozzle. The hopper is configured to store a predetermined volume of a granular food product (e.g., at least 15 ounces) and is configured to convey a stream of the granular food product into the stream of liquid to form a mid-stream mixture. The mixing and dispensing device also includes a dispensing actuator operable to actuate the pump and/or the electric motor, and control electronics coupled to the pump and the electric motor. The control electronics are configured to control operation of the pump and the electric motor based upon activation of the dispensing actuator.

The liquid reservoir can be removably mounted to the housing. In some cases, the liquid reservoir is at least partially transparent such that a user can visibly determine a level of liquid in the liquid reservoir.

In some embodiments, the hopper is at least partially transparent such that a user can visibly determine a level of granular food product in the hopper. In some cases, the hopper is removably mounted within the housing. In such cases, the housing can include a transparent window such that a user can visibly determine a level of the granular food product in the hopper when the hopper is disposed within the housing. The housing can also include a lighting assembly disposed within the housing proximate the hopper and operable to illuminate the hopper such that the level of granular food product in the hopper is visible through the transparent window.

The housing can include a carry handle for portability.

According to some embodiments, the mixing and dispensing device can also include a heating element disposed between the liquid reservoir and the liquid supply nozzle. The heating element being configured to heat the supply of liquid to a predetermined temperature (e.g., between about 90° F. and about 104° F.) as it is conveyed from the liquid reservoir to the liquid supply nozzle. In some cases, the heating element is configured to heat the supply of liquid to the predetermined temperature within about 5 minutes or less.

The mixing and dispensing device can also include a control panel connected to the control electronics. The control panel is configured to allow a user to select from one or more user inputs. The control panel can include a heating element on/off switch to allow the user to control a temperature of dispensed liquid; a dispensing options switch to allow the user to select a dispensed product, wherein the dispensed product is selected from the group consisting of the granular food product, liquid, and a mixture of liquid and the granular food product; a serving size switch to allow the user to indicate a volume of a product to be dispensed; and/or a granulated food product selection switch to allow the user to indicate a type of granulated food product to be dispensed. In some cases, the granulated food product selection switch is operable to control a volume of the granulated food product that is dispensed.

In some embodiments, the control electronics can include an on/off switch for energizing the device.

According to yet another aspect, a method of mixing and dispensing a beverage includes dispensing a stream of liquid from a liquid supply nozzle to a container; filling a hopper with a predetermined volume of a granular food product; conveying a stream of the granular food product from the hopper into the stream of liquid, thereby forming a mixed product upstream of the container; and dispensing the mixed product into the container.

In some embodiments, the method can also include filling a liquid reservoir with a predetermined volume of liquid. In such cases, dispensing the stream of liquid can include conveying liquid from the liquid reservoir to the liquid supply nozzle and forcing the liquid through the liquid supply nozzle and into the stream of granular food product.

The method can also include heating the liquid to a predetermined temperature (e.g., between about 90° F. and about 104° F.) as it is conveyed from the liquid reservoir to the liquid supply nozzle. In some cases, heating the liquid includes heating the liquid from a temperature of between about 65° F. and about 72° F. to the predetermined temperature in about 5 minutes or less.

In some implementations, the method can include actuating the dispensing of the mixed product. Actuating the dispensing of the mixture can include engaging a dispensing actuator with the container. In some cases, engaging the dispensing actuator includes placing the container in contact with the dispensing actuator.

In another aspect, a method of mixing and dispensing a beverage includes filling a hopper with a predetermined volume of a granular food product; conveying a stream of the granular food product from the hopper to a container; forcing a stream of liquid into the stream of granular food product upstream of the container, thereby forming a mixed product; and collecting the mixed product in the container.

The method can also include filling a liquid reservoir with a predetermined volume of liquid. In this case, forcing the stream of liquid into the stream of dry formula can include conveying liquid from the liquid reservoir to a liquid supply nozzle and forcing the liquid through the liquid supply nozzle and into the stream of the granular food product.

In some embodiments, the method also includes heating the liquid to a predetermined temperature as it is conveyed from the liquid reservoir to the liquid supply nozzle.

The details of one or more embodiments are set forth in the accompanying drawings and the description below. Other features and advantages will be apparent from the description and drawings, and from the claims.

### DESCRIPTION OF DRAWINGS

FIG. 1 is a front view of a beverage mixing and dispensing device.

FIG. 2 is a side view of the beverage mixing and dispensing device of FIG. 1.

FIG. 3 is a cross-sectional view of the beverage mixing and dispensing device of FIG. 1, taken along line 3-3 of FIG. 1.

FIG. 4 is a cross-sectional perspective view of a hopper subassembly.

FIG. 5 is a perspective view of a hopper subassembly with the lid removed.

FIG. 6A is a plan view of a liquid supply nozzle.

FIG. 6B is a cross-sectional side view of the liquid supply nozzle of FIG. 6A, take along line 6B-6B.

FIG. 7A is a plan view of an alternative embodiment of the liquid supply nozzle of FIG. 6A.

FIG. 7B is a cross-sectional side view of the liquid supply nozzle of FIG. 7A, taken along line 7B-7B.

FIG. 8 is a schematic diagram of the device of FIG. 1 showing mixing of a granulated food product and a liquid, and dispensing of a mixed product.

FIG. 9 is a schematic diagram of a liquid supply system of the beverage mixing and dispensing device of FIG. 1.

Like reference symbols in the various drawings indicate like elements.

### DETAILED DESCRIPTION

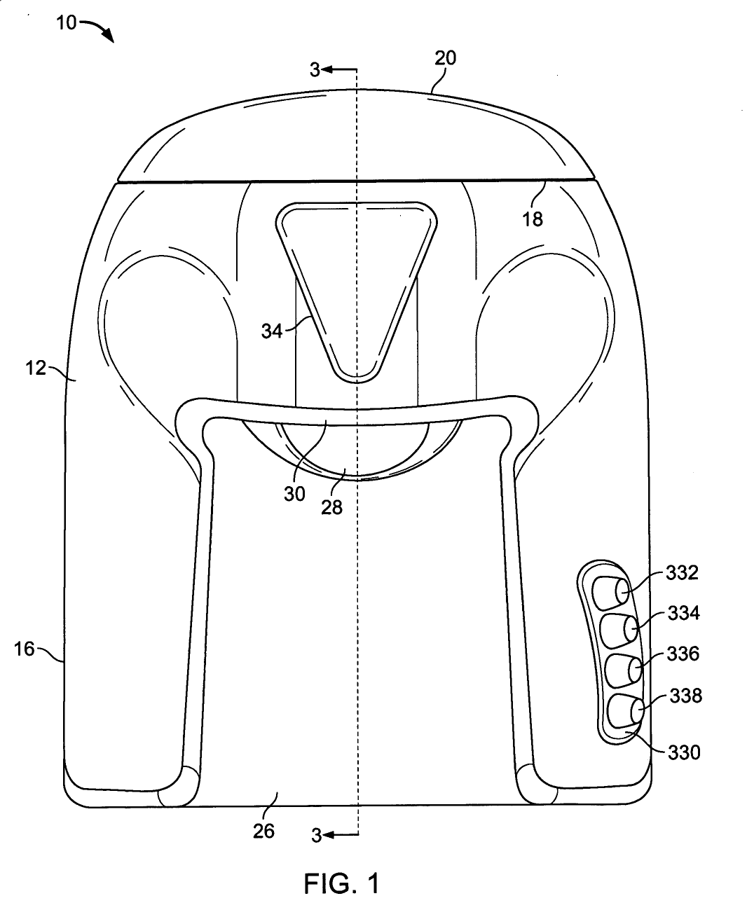

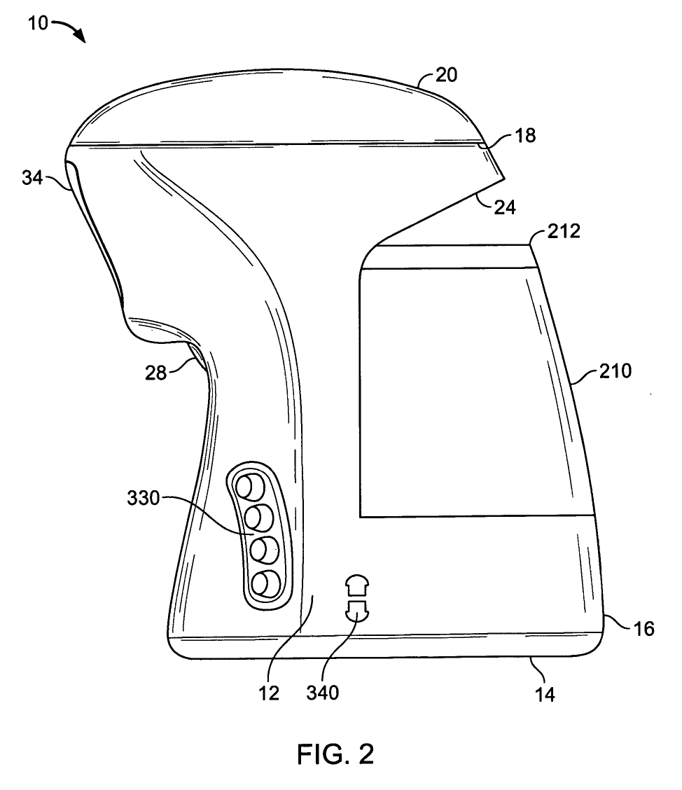

Referring generally to FIGS. 1 and 2, a beverage mixing and dispensing device 10 is shown. The device 10 is operable to mix a granular food product (e.g., dry infant formula, instant coffee, a powdered drink mix, e.g., iced tea mix, etc.) with a stream of liquid mid-stream, e.g., without the use of a mixing container, before or during deposition of the liquid as it is dispensed into a container (e.g., a cup, bowl, baby bottle, etc.). More specifically, the device 10 can be configured to measure, heat, mix, and dispense a mixed beverage comprising a granular food product mixed and/or dissolved in liquid. The device is configured to dispense, at the discretion of a user, a single serving of liquid (hot or cold), a single serving of dry granular food product (e.g., for travel), or a mixed beverage (i.e., granular food product mixed with liquid).

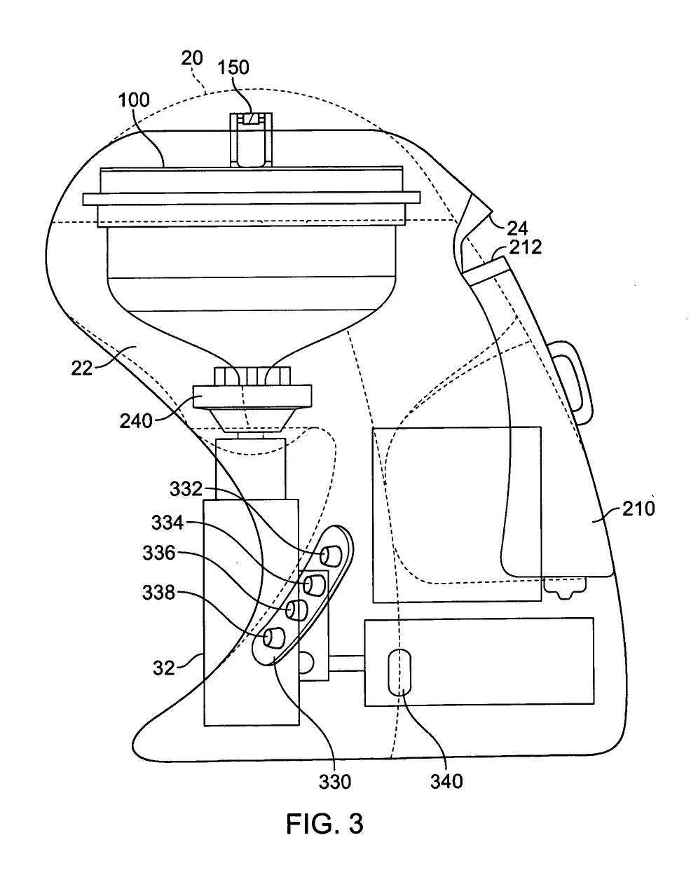

Referring still to FIGS. 1 and 2, the device 10 includes a housing 12 that forms a general frame for the device 10 and provides a support for various operative components of the device, as discussed in greater detail below. The housing 12 includes a base member 14 and a substantially upright wall 16 supported by the base member 14. The upright wall 16 extends from the base member 14 to an open end 18. A cover 20 is removably and or rotatably mounted at the open end 18 of the housing, thereby providing access to an internal cavity 22 (as shown in FIG. 3) of the housing. As shown, for example, in FIG. 2, the housing 12 can include a carry handle 24 for portability.

According to the embodiment depicted in FIGS. 1 and 2, the housing 12 also includes a dispensing station 26 disposed generally in a front region of the device. The device can also include a dispenser actuator 28, which, as illustrated, for example, in FIGS. 1 and 2, extends through an aperture 30 defined by the housing 12 and is disposed generally in the region of the dispensing station. In operation, the placement of a container 32 in the dispensing station 26 engages the dispenser actuator 28, as shown in FIG. 3, and initiates dispensing of a product.

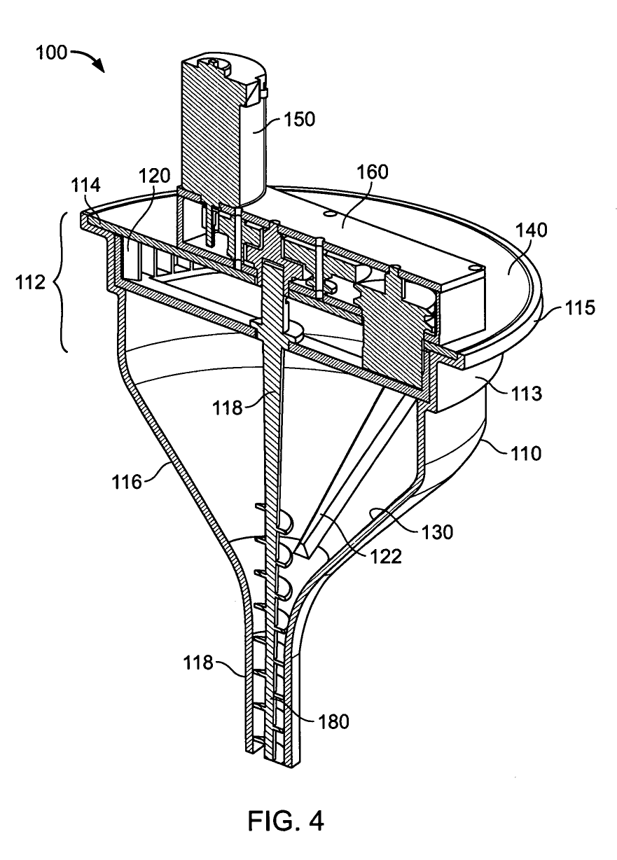

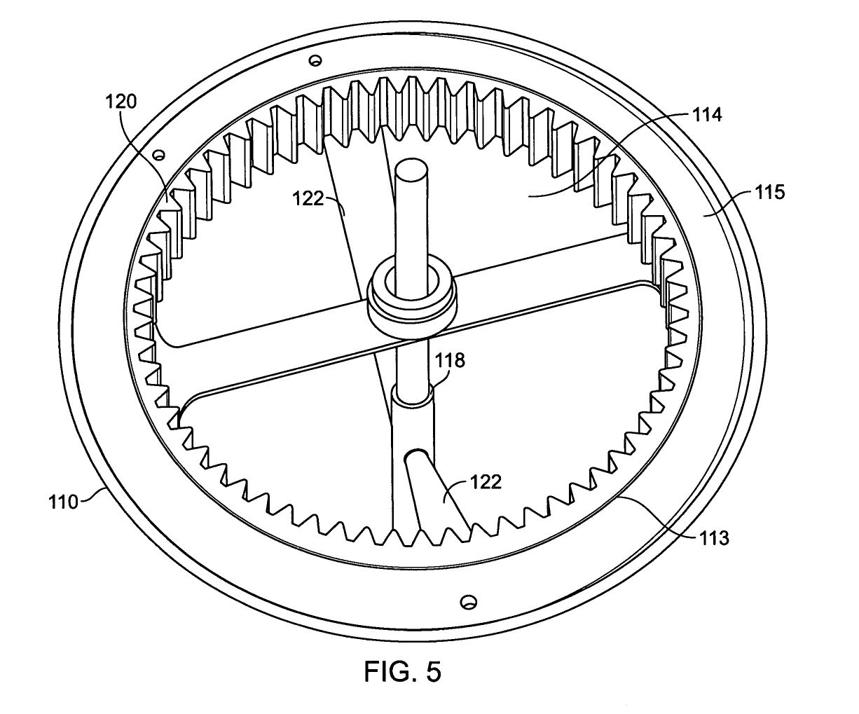

Referring now to FIGS. 3-5, and 9, the device 10 generally includes in one example a hopper subassembly 100, a liquid supply system 200, and a dispensing control system (not shown). The hopper subassembly 100 is configured for storing and dispensing a granular food product. With specific reference to FIGS. 4-5, the hopper subassembly 100 includes a funnel-shaped hopper container (i.e., hopper container 110) configured to store a predetermined volume of a granular food product, e.g., a capacity of at least about 15 ounces, or at least enough for about eight single servings, e.g., of baby formula. The hopper container 110 includes an upper cylindrical wall section 112 extending from a first open end 114 joined to a tapered section 116, which terminates in a relatively narrow spout 118. The upper cylindrical wall section 112 defines first and second annular stepped regions 113, 115. The first annular stepped region 113 supports a ring gear 120. More specifically, the ring gear 120 is rotatably mounted in the first annular stepped region 113. A pair of sweeping arms 122 extend from a bottom surface of the ring gear 120 and substantially conform to the contours of an inner surface 130 of the hopper container 110. As shown in FIG. 4, the second annular stepped region 115 supports a lid 140, which forms a substantially air-tight seal with the hopper container 110. In some cases, a seal (e.g., o-ring, gasket, etc.) can also be used with any suitable connection to form an air-tight seal between the lid 140 and the hopper container 110. An electric motor 150 and gear drive assembly 160 are disposed on an upper surface of the lid 140. The motor 150 is driven through control electronics (not shown), as described below, and, in turn, drives the gears of the gear drive 160. The gear drive 160 is configured to engage the ring gear 120, thereby causing the ring gear 120 to rotate about a central axis of the hopper 100, and, as a result, the sweeping arms 122 rotate along the inner surface 130 of the hopper container 110, thereby reducing accumulation of the granular food product (not shown) along the inner surface 130. The hopper subassembly 100 also includes an auger 180 drivably connected to the electric motor 150 through the gear drive and disposed within the hopper container 110 in coaxial relation to the ring gear 120. The auger 180 extends into the spout 118 and is configured to convey the granular food product from the hopper container 110, through the spout 118 and into a stream of liquid, as described below. The hopper subassembly 100 can be removed, e.g., for cleaning and refilling, through the open end 18 of the housing 12 by removing the cover 20. More specifically, the housing 12 defines a receptacle, which is configured to receive and support the hopper subassembly 100. In some cases, the hopper container 110 is at least partially transparent such that a user can visibly determine a level of granular food product in the hopper. For example, the hopper container 110 can be a molded article formed from a transparent plastic. In these cases, the housing can also include a transparent window such that a user can visibly determine a level of the granular food product in the hopper container 110 when the hopper is disposed within the housing 12. As shown in FIG. 3, the housing can also include a lighting assembly 190 disposed within the housing proximate the hopper subassembly 110 and operable to illuminate the hopper subassembly 100 such that the level of granular food product in the hopper is visible when the hopper container 110 is disposed within the housing 12.

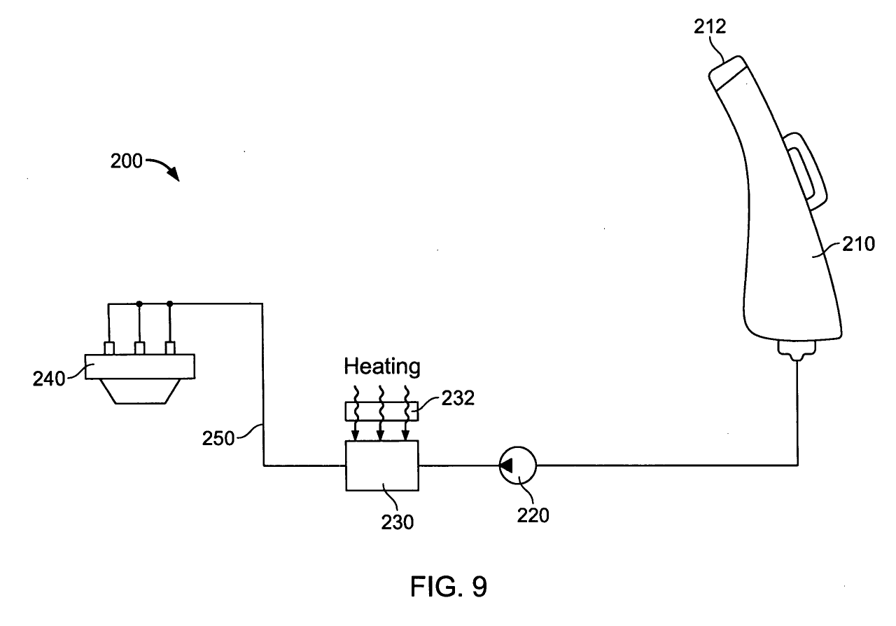

As shown schematically in FIG. 9, the device 10 also includes a liquid supply system 200 for storing and dispensing liquid, and/or for mixing with the granular food product (i.e., to form a mixed beverage). The liquid supply system includes a liquid reservoir 210, a pump 220, a heating chamber 230, and a liquid supply nozzle 240. The liquid reservoir 210 can be removable and sized to hold a predetermined volume of liquid, e.g., at least about 32 ounces, or at least enough for about eight single servings of baby food formula, for example. In some embodiments, the liquid reservoir can be integrally molded with the housing. Liquid can also be provided directly to the system from an external source. The liquid reservoir 210 can include transparent sidewalls allowing the user to visibly determine a level of liquid in the liquid reservoir 210. The liquid reservoir 210 can include a cover 212, and, in some cases, a seal (e.g., o-ring, gasket, etc.) can also be used with any suitable connection to form an air tight seal between the cover 212 and the liquid reservoir 210.

The pump 220 is driven through control electronics (not shown), discussed in greater detail below, and is configured to control the flow of liquid through the system. Specifically, the pump 220 draws a predetermined supply of liquid according to user input to the control electronics, e.g., a single serving volume of liquid, from the liquid reservoir 210 and into the heating chamber 230, and, ultimately to the liquid supply nozzle 240 for dispensing. The heating chamber 230 includes a heating element 232, e.g., a resistive heating element, etc., for heating the supply of liquid as it passes through the heating chamber 230. In some cases, the heating chamber 230 is configured for “on the spot” heating, for example, the heating chamber 230 can be configured to heat the supply of liquid (e.g, 2-8 ounces of liquid) to a temperature of between about 90° F. to about 105° F. in about 5 minutes or less as it is conveyed through the heating chamber 230. Liquid conduit tubing (i.e., fluid lines 250) connects an output of the heating chamber to an input port of the liquid supply nozzle 240. Preferably, the system 200 is configured such that the heating chamber 230, the pump 220, the liquid supply nozzle 240, and the corresponding fluid path(s) are substantially void of liquid between dispensing cycles. For example, individual dispensing cycles can conclude with a purge phase, thereby substantially removing residual liquid from the heating chamber 230, the pump 220, the liquid supply nozzle 240, and fluid lines 250. Furthermore, the liquid supply system 200 can be configured such that substantially all liquid remaining in the heating chamber 230, the pump 220, and/or the fluid lines 250 following a dispensing cycle will drain back into the liquid reservoir 210.

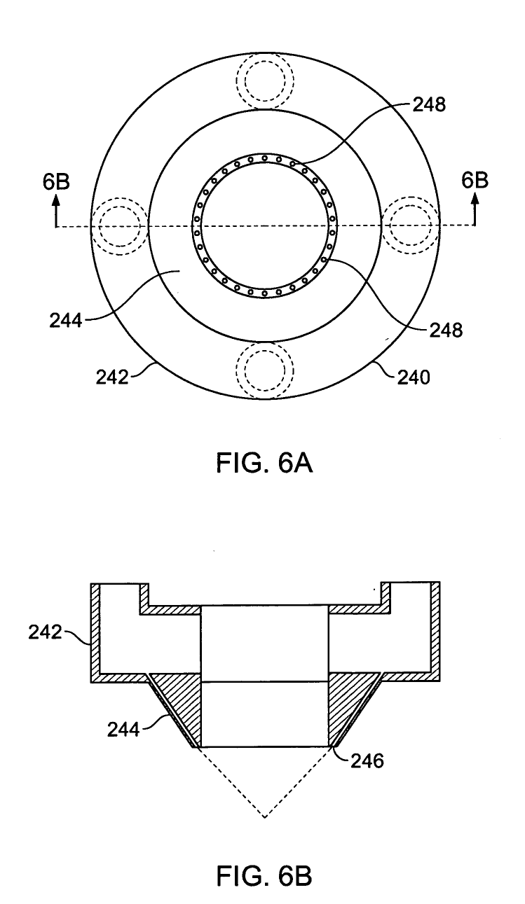

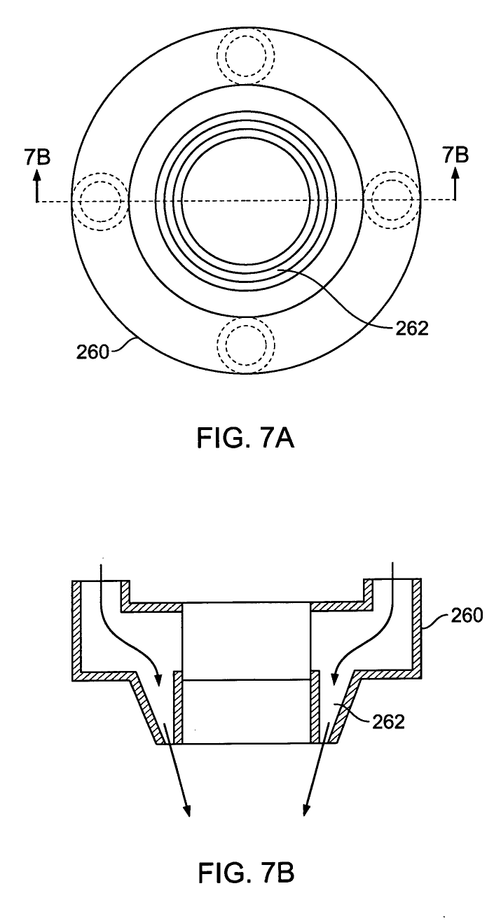

Referring again to FIG. 3, the liquid supply nozzle 240 is disposed within the housing 12 in a position downstream of the hopper subassembly 100, and in coaxial relation to the spout 118. In the embodiment shown in FIGS. 6A and 6B, the liquid supply nozzle 240 generally comprises an annular ring including a cylindrical base 242 and a tapered head 244 extending from a bottom surface of the base 242. At a lower surface 246 of the tapered head 244, opposite the base 242, the liquid supply nozzle 240 defines a plurality of apertures (i.e., fluid jets 248) configured to dispense the supply of liquid from the system in a continuous stream or a plurality of circumferentially arranged streams for example. Generally, the size and shape of the aperture(s) can be formed as desired. Any suitable aperture shape (e.g., circular, elliptical, square, etc.), and/or configuration of apertures can be employed to provide a desired flow rate and mixture with the granular food product. For example, referring to FIG. 6A, the nozzle 240 includes a number of relatively small apertures 248. In another embodiment, referring to FIGS. 7A and 7B, a liquid supply nozzle 260 includes a substantially annular ring defining a substantially frusto-conical fluid channel 262 configured to dispense a stream of liquid in the form of a vortex, for example.

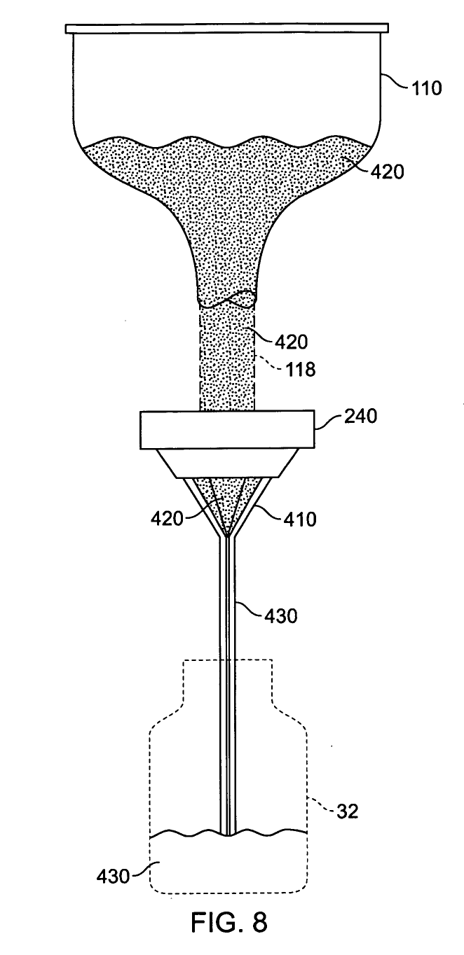

With continued reference to FIGS. 6A and 6B, in operation, liquid is forced through the jets 248 at the lower surface 246 of the liquid supply nozzle 240. As shown schematically in FIG. 8, for example, streams of liquid 410 from the jets 248 converge on the granular food product 420 as it is dispensed from the spout 118, thereby causing mixing of the liquid and the granular food product mid-stream. A mixed product 430 (i.e., a mixture comprising liquid and the granular food product) is thus delivered to the container 32 without the need for further mixing, e.g., in a separate mixing chamber, and without requiring additional mechanical influence, e.g., stirrers, mixing blades, etc. This provides a continuous, rather than batch process and can reduce the likelihood that the granular food product will coagulate, cake, or solidify in the device as it is conveyed and dispensed to the container.

The device 10 also includes a dispensing control system (not shown), including a power supply (not shown), control electronics (not shown), and a control panel 330 (user interface). The power supply selectively provides power to the heating element 232, the electric motor 150, and the pump 220 through the control electronics. In some examples, the power supply is configured for dual voltage operation; i.e., the power supply is configured to operate with either a 220VAC/50 Hz or a 110VAC/60 Hz supply. More specifically, where the system electronics are configured to operate with a 110 VAC supply, the power supply is configured to convert a 220VAC source to 110VAC. An on/off switch 340 selectively supplies power to the control electronics.

The control electronics are configured to control operation of the pump 220, the heating element 232, and/or the electric motor 150 based on user inputs from the control panel 330, and/or sensor inputs (e.g., input from the dispenser actuator). More specifically, the control electronics are configured to control the operation and speed of the pump 220 and the electric motor 150 based, at least in part, on input from the dispensing actuator 28. In some embodiments, the control electronics are also configured to control the pump 220 and the electric motor 150 based on sensor inputs. For example, the dispensing control system can also include sensors or indicators (not shown) for monitoring the level of liquid and/or granular food product in the device 10. The dispensing control system can include, for example, a low level sensor for sensing when liquid in the reservoir 210 falls below a predetermined level. More specifically, a liquid level sensor can be disposed in the liquid reservoir 210 and electrically connected to the control electronics. The control electronics can be configured to deactivate operation of the pump 220 and/or the electric motor 150 based upon a signal from the liquid level sensor indicating that the liquid level has dropped below the predetermined minimum level. Additionally, the dispensing control system can also include a granular food product level sensor disposed within the hopper container 110, for example, to provide a signal to the control electronics indicating when the level of food product in the device falls below a predetermined minimum level. The control electronics can be configured to deactivate the operation of the device 10 (e.g., the electric motor and/or the pump) and/or provide an audio or visual signal to the user in response to a signal from the level indicator indicating that the level of granular food product in the hopper container 110 has dropped below the predetermined minimum level.

Referring again to FIGS. 1-3, the control panel 330 includes a plurality of individual controls (e.g., rotary, toggle, or point contact electrical switches), which allow the user to select from a variety of options. For example, the control panel 330 can include a heating element on/off switch 332 to provide the user the option of turning off the heating element 232. The control panel 330 can also include a dispensing options switch 334 to allow the user to select the dispensed product. For example, the user can select to dispense granular food product alone, liquid alone, or a mixed beverage (i.e., a mixture of the granular food product and liquid). The control panel 330 can also include a serving size switch 336 to allow the user to indicate a volume (e.g., 2 to 8 ounce single servings) of a product to be dispensed. The control panel 330 can also include a granulated food product selection switch 338 to allow the user to input to the control electronics the particular type of granulated food product to be dispensed. In some embodiments, the control electronics control the feed rate of the granular food product based on properties of the granulated food product such as granule size, granule consistency, manufacturer's recommended serving size, etc., based on the input from the food product selection switch 338. In some embodiments, the food product selection switch includes a plurality of settings with each individual setting corresponding to a predetermined product or group of products which share similar properties described above.

Referring to FIGS. 3 and 8, in use, a container 32 is placed in position in the dispensing station 26, i.e., in engagement with the dispenser actuator 28, thereby initiating a dispensing cycle. More specifically, the dispenser actuator 28 delivers a signal to the control electronics signaling the presence of the container 32 in the dispensing station 26. In response, the control electronics actuate the pump 220 and/or electric motor 150 of the hopper subassembly 100. Preferably, the pump 220 is actuated prior to actuation of the electric motor 150, thereby to ensure the presence of a fluid stream before granular food product is dispensed from the hopper container 110, thereby helping to ensure that the dispensed granular food product is mixed with the liquid before it is received in the container 32. However, it is to be understood that other embodiments are within the scope of the claimed invention. For example, as mentioned above, in some embodiments the device 10 is operable to dispense liquid only (either heated liquid or room temperature) and/or the granular food product only. Furthermore, in some embodiments, the device 10 is configured such that the dispensing cycle of the granular food product is completed before the dispensing cycle of the liquid is completed, thereby to ensure that that the granular food product is dispensed from the hopper container 110 and into the stream of liquid, and, thus, mixed with the liquid mid-stream before it is delivered to the container 32. For example, in one embodiment, the dispensing of the water begins seconds before the dispensing of the granular food product and continues for a predetermined period of time after the dispensing of the granular food product has ceased.

As mentioned above, the control electronics control operation of the pump 220. The pump 220 draws a supply of liquid, e.g., a single serving volume of liquid, from the liquid reservoir 210 and forces it through the heating chamber 230, and ultimately through the liquid supply nozzle 240. The heating element 232 heats the supply of liquid as it passes through the chamber 230 on its way to the liquid supply nozzle 240. The supply of liquid is dispensed from the liquid supply nozzle 240 such that a stream of liquid forms, converging on a central axis. In a substantially concurrent operation, the control electronics actuate operation of the electric motor 150. The electric motor 150 drives the gear drive assembly 160, which, in turn, drives the auger 180 and sweeping arms 122, thereby conveying a supply of the granular food product (e.g., a single serving volume of the granular food product) from the hopper container 110 and dispensing a stream of granular food product through the spout 118. The stream of granular food product is dispensed from the spout 118 and falls, due to gravity, into the converging stream of liquid. The stream of liquid and the stream of granular food product mix mid-stream (i.e., without the need for a separate mixing container and without additional mechanical influence, e.g., mixing blades, stirrers, etc.) immediately before or while entering the container. Thus, a mixed product is delivered to the container 32. For example, in some cases, the water supply nozzle 240 and the spout 18 are configured such that the stream of water converges on the stream of granular food product for mid-stream mixing in the region of the dispensing station 26, i.e., in a region external to the housing 12. The device 10 can optionally include a dispensing nozzle 15 (as indicated with hidden lines in FIGS. 3 and 8) disposed in the region of the dispensing station 26 in a position down stream of the water supply nozzle 240, wherein the water supply nozzle 240 and the spout 118 are configured such that the stream of water converges on the stream of granular food product for mid-stream mixing within the dispensing nozzle 15. The dispensing nozzle 15 can be at least partially transparent such that a user can visibly observe the mid-stream mixing of the water and the granular food product as it passes through the dispensing nozzle 15 en route to the container 32. In some examples, the control electronics continue to operate the pump 220 and/or electric motor 150 until the dispensing cycle is complete, or until the container 32 is moved out of engagement with the dispenser actuator 28.

A number of embodiments of the invention have been described. Nevertheless, it will be understood that various modifications may be made without departing from the spirit and scope of the invention. Accordingly, other embodiments are within the scope of the following claims.

What is claimed is:

1. A beverage mixing and dispensing device; comprising:
a housing;
a liquid supply nozzle supported by the housing and configured to dispense a stream of liquid;
a liquid supply mechanism in fluid communication with the liquid supply nozzle and configured to convey a supply of liquid to the liquid supply nozzle for dispensing; and
a hopper configured to store a predetermined volume of a granular food product and configured to convey a stream of the granular food product into the stream of liquid,
wherein the liquid supply nozzle is configured such that the stream of liquid and 11 the stream of the granular food product mix mid-stream to dispense a mixed product.

2. The beverage mixing and dispensing device according to claim 1, wherein the liquid supply mechanism comprises:
a liquid reservoir configured to store a predetermined volume of liquid; and
a liquid pump configured to draw the supply of liquid from the predetermined volume of liquid and to convey the supply of liquid to the liquid supply nozzle.

3. The beverage mixing and dispensing device according to claim 2, wherein the liquid supply mechanism further comprises a heating element configured to heat the supply of liquid conveyed from the liquid reservoir to the liquid supply nozzle.

4. The beverage mixing and dispensing device according to claim 3, wherein the heating element is configured to heat the supply of liquid to a temperature of between about 90° F. to about 104° F. in about 5 minutes or less.

5. The beverage mixing and dispensing device according to claim 2, wherein the liquid reservoir is removably mounted to the housing.

6. The beverage mixing and dispensing device according to claim 1, wherein the housing defines a chamber configured to receive the hopper, and wherein the hopper is removably mounted within the chamber.

7. The beverage mixing and dispensing device according to claim 1, wherein the hopper comprises:
a funnel-shaped container defining a first open end configured to receive the predetermined volume of granular food product, and including a granule compartment extending from the first open end, defining an inner surface for storing the granular food product, and terminating in a substantially cylindrical spout;
an electric motor disposed proximate the funnel shaped container; and
an auger drivably connected to the electric motor and configured to convey the granular food product from the granule compartment through the spout.

8. The beverage mixing and dispensing device according to claim 7, wherein the hopper further comprises one or more sweeping arms drivably connected to the electric motor and configured to loosen granular food product from the inner surface of the funnel-shaped container.

9. The beverage mixing and dispensing device according to claim 7, wherein the liquid supply nozzle comprises an annular ring defining a fluid path extending from one or more input ports and terminating in a plurality of fluid jets, wherein the liquid supply nozzle is disposed in co-axial relation with the spout of the hopper.

10. The beverage mixing and dispensing device according to claim 7, wherein the liquid supply nozzle comprises an annular ring defining a substantially frusto-conical fluid channel configured to dispense the stream of liquid in the form of a vortex.

11. The beverage mixing and dispensing device according to claim 7, wherein the granulated food product is a powdered drink mix, instant coffee, or dry infant formula.

12. The beverage mixing and dispensing device according to claim 1, further comprising a dispenser actuator operable to actuate the hopper and liquid supply mechanism for substantially concurrent dispensing of the stream liquid and the stream of granulated food product.

13. The beverage mixing and dispensing device according to claim 1, wherein the stream of liquid corresponds to a single serving volume of liquid.

14. The beverage mixing and dispensing device according to claim 1, wherein the stream of granulated food product corresponds to a single serving volume of the granulated food product.

15. A mixing and dispensing device, comprising:
a housing;
a liquid reservoir configured to store a predetermined volume of liquid;
a liquid supply nozzle in fluid communication with the liquid reservoir, wherein the liquid supply nozzle is configured to dispense a stream of liquid;
a pump connected between the liquid supply nozzle and the liquid reservoir and configured to convey a supply of liquid from the liquid reservoir to the liquid supply nozzle;
an electric motor;
a hopper drivably connected to the electric motor, wherein the hopper is disposed within the housing in a position upstream of the liquid supply nozzle, and wherein the hopper is configured to store a predetermined volume of a granular food product and configured to convey a stream of the granular food product into the stream of liquid, thereby to form a mid-stream mixture;
a dispensing actuator operable to actuate at least one of the pump and the electric motor; and
control electronics coupled to the pump and the electric motor, wherein the control electronics are configured to control operation of the pump and the electric motor based upon activation of the dispensing actuator.

16. The mixing and dispensing device of claim 15, wherein the liquid reservoir is removably mounted to the housing.

17. The mixing and dispensing device of claim 15, wherein the liquid reservoir is at least partially transparent such that a user can visibly determine a level of liquid in the liquid reservoir.

18. The mixing and dispensing device of claim 15, wherein the hopper is at least partially transparent such that a user can visibly determine a level of granular food product in the hopper.

19. The mixing and dispensing device of claim 18, wherein the hopper is removably mounted within the housing, and wherein the housing includes a transparent window such that a user can visibly determine a level of the granular food product in the hopper when the hopper is disposed within the housing.

20. The mixing and dispensing device of claim 19, further comprising a lighting assembly disposed within the housing proximate the hopper and operable to illuminate the hopper such that the level of granular food product in the hopper is visible through the transparent window.

21. The mixing and dispensing device of claim 15, wherein the housing includes a carry handle for portability.

22. The mixing and dispensing device of claim 15, wherein the predetermined volume of liquid is at least 32 ounces.

23. The mixing and dispensing device of claim 15, wherein the predetermined volume of granular food product is at least 15 ounces.

24. The mixing and dispensing device of claim 15, further comprising a heating element disposed between the liquid reservoir and the liquid supply nozzle and configured to heat the supply of liquid to a predetermined temperature as it is conveyed from the liquid reservoir to the liquid supply nozzle.

25. The mixing and dispensing device of claim 24, wherein the predetermined temperature is in a range of between about 90° F. and about 104° F.

26. The mixing and mixing and dispensing device of claim 25, wherein the heating element is configured to heat the supply of liquid to the predetermined temperature within about 5 minutes or less.

27. The mixing and dispensing device of claim 24, further comprising a control panel connected to the control electronics, wherein the control panel is configured to allow a user to select from one or more user inputs.

28. The mixing and dispensing device of claim 27, wherein the control panel includes a heating element on/off switch to allow the user to control a temperature of dispensed liquid.

29. The mixing and dispensing device of claim 27, wherein the control panel includes a dispensing options switch to allow the user to select a dispensed product, wherein the dispensed product is the granular food product, liquid, or a mixture of liquid and the granular food product.

30. The mixing and dispensing device of claim 27, wherein the control panel includes a serving size switch to allow the user to indicate a volume of a product to be dispensed.

31. The mixing and dispensing device of claim 27, wherein the control panel includes a granulated food product selection switch to allow the user to indicate a type of granulated food product to be dispensed.

32. The mixing and dispensing device of claim 31, wherein the granulated food product selection switch is operable to control a volume of the granulated food product that is dispensed.

33. The mixing and dispensing device of claim 15, wherein the control electronics include an on/off switch for energizing the device.

34. A method of mixing and dispensing a beverage, the method comprising:
dispensing a stream of liquid from a liquid supply nozzle to a container;
filling a hopper with a predetermined volume of a granular food product;
conveying a stream of the granular food product from the hopper into the stream of liquid, thereby forming a mixed product upstream of the container; and
dispensing the mixed product into the container.

35. The method according to claim 34, further comprising filling a liquid reservoir with a predetermined volume of liquid, and
wherein dispensing the stream of liquid comprises conveying liquid from the liquid reservoir to the liquid supply nozzle and directing the liquid through the liquid supply nozzle and into the stream of granular food product.

36. The method according to claim 35, further comprising heating the liquid to a predetermined temperature as the liquid is conveyed from the liquid reservoir to the liquid supply nozzle.

37. The method according to claim 36, wherein the predetermined temperature is between about 90° F. and about 104° F.

38. The method according to claim 36, wherein heating the liquid includes heating the liquid from a temperature of between about 65° F. and about 72° F. to the predetermined temperature in 5 minutes or less.

39. The method according to claim 34, further comprising dispensing the mixed product by urging the container toward a dispenser actuator.

40. A method of mixing and dispensing a beverage, the method comprising:
filling a hopper with a predetermined volume of a granular food product;
conveying a stream of the granular food product from the hopper to a container;
forcing a stream of liquid into the stream of granular food product upstream of the container, thereby forming a mixed product; and
collecting the mixed product in the container.

41. The method according to claim 40, further comprising filling a liquid reservoir with a predetermined volume of liquid, and wherein forcing the stream of liquid into the stream of dry formula comprises conveying liquid from the liquid reservoir to a liquid supply nozzle and forcing the liquid through the liquid supply nozzle and into the stream of the granular food product.

42. The method according to claim 41, further comprising heating the liquid to a predetermined temperature as the liquid is conveyed from the liquid reservoir to the liquid supply nozzle.
